(19) United States
(12) Patent Application Publication
(10) Pub. No.: US 2015/0294221 A1
(43) Pub. Date: Oct. 15, 2015

(54) A METHOD AND A SYSTEM FOR GENERATING CONTEXT-BASED CONTENT RECOMMENDATIONS TO USERS

(71) Applicant: Telefonica, S.A., Madrid (ES)

(72) Inventors: Juan Jose ANDRES GUTIERREZ, Madrid (ES); Paulo VILLEGAS NUNEZ, Madrid (ES); Manuel MARTIN MARTINEZ, Madrid (ES); Javier SIERRA MERINO, Madrid (ES); Francisco Jose RODRIGUEZ PEREZ, Madrid (ES)

(73) Assignee: Telefonica, S.A., Madrid (ES)

(21) Appl. No.: 14/414,588

(22) PCT Filed: Jul. 10, 2013
(86) PCT No.: PCT/EP2013/064543

§ 371 Date: Jan. 13, 2015

(30) Foreign Application Priority Data
Jul. 13, 2012 (ES) P201231106

(51) Int. Cl. G06N 5/04

(52) U.S. Cl. CPC G06N 5/04

(57) ABSTRACT

A method and a system for generating content recommendations to users.

The method comprising:
a first user connected through a mobile device to a server, and determining a physical location of said first user mobile device, the method further comprising:
   a) performing a frequency scan, said first user mobile device, to discover the presence of a plurality of other users' mobile devices in proximity;
   b) obtaining, said first user mobile device, a network identifier for each one of said plurality of mobile devices discovered;
   c) gathering and sending each one of said network identifiers to said server;
   d) matching, said server, network identifiers received with other users identifiers known by said server,
   e) predicting affinity between said first user and other based on an spatio-temporal clustering analysis
   f) storing and analyzing, said server, said affinity prediction in order to provide said content recommendations upon said first user mobile device request

The system of the invention is arranged to implement the method of the invention

### FIELD OF THE ART

This invention generally relates, in a first aspect, to a method for generating context-based content recommendations to users of mobile devices, and more particularly to a method for generating said content recommendation based on predicting affinity between users from spatio-temporal proximity information of said users.

A second aspect of the invention relates to a system arranged to implement the method of the first aspect.

By means of mobile devices it will be understood: smartphones, PDAs, tablet PCs, portable media player, etc.

### BACKGROUND OF THE PRESENT INVENTION

Recommender systems typically produce a list of recommendations through collaborative filtering. Collaborative filtering recommendation systems build a model from a user's past behavior (items previously purchased or selected and/or numerical ratings given to those items) as well as similar decisions made by other users, then use that model to predict items (or ratings for items) that the user may have an interest in.

Collaborative filtering systems have many forms, but many common systems can be reduced to two steps:
Look for users who share the same rating patterns with the active user (the user whom the prediction is for).
Use the ratings from those like-minded users found in step 1 to calculate a prediction for the active user

Some collaborative filtering systems are based on implicit observations of normal user behavior (as opposed to the artificial behavior imposed by a rating task). In these systems it can be observed what a user has done together with what all users have done (for example, what music they have listened to, what items they have bought) and use that data to predict how a user might like a new item in the future.

There exist some patents related to recommendation for users. For example, the patent application US 2009/0030792 discloses a method and system for content recommendation that make person-to-person recommendations possible, even if users are in different geographic locations, use different network service providers and different services, use different types of device, etc. This system is not specifically based on collaborative-filtering and it is aimed at users viewing content that they want to recommend to other people, such as their friends.

On the other hand, the US 2009/0228211 discloses a recommendation system wherein the location of a wireless device is utilized to provide recommendations to its user that are appropriate to the device's current environment and user context. This system is not specifically based on collaborative-filtering and it is aimed at users accessing augmented reality data services based on the location or context of the wireless device, and further provides a system and method for providing recommendations on user location(s) and/or preferences.

In US 2006/0085419 it is disclosed a system a method for creating social networks using locations that have been visited by several users. This system uses location information only to shape each user's profile and adjust it to reality, which would lead to a more realistic (and thus trustable) social network. The system is aimed at generating and collecting profile information regarding people and entities and matching or filtering said people and entities based on that profile information.

Other systems which propose recommendation to users can be found for example in [1], which proposes a system to build meaningful social networks based on implicit relationships between people and how those relationships affect their personal context. This context could be later on used for providing contextualized mobile recommendation services at a certain time and place.

In [2] are proposed algorithms to discover potential relationships between people based on analysing their spatio-temporal events. The underlying idea is that two individuals that are in the same place at the same time could be somehow related in their real life. The strength of this association is given by a weight. It can be noted however, that both procedures for mapping spatio-temporal events to users (in which they limit themselves to both spatial and temporal coincidence) as well as their intended use is markedly different from the one used in the present invention.

Finally, [6] introduces a scalable and efficient algorithm to predict the location of an individual from a set of located users. Once more, the increasing time people spend online shows more precisely the mutual dependency between geographical location and social relationships. This information is relevant for location-based services, for instance.

### Problems with Existing Solutions

Although there are content recommendation systems based on collaborative-filtering that also consider user context (context-aware recommender systems), current solutions do not provide the requesting user with content recommendations coming from like-minded users, where user affinity is simultaneously computed from:
User profile similarities, measured by matching content usage history through standard mechanisms: “people who like the same things that I do”.
Current physical proximity, as detected by server-side pairing of device identifiers among users of the service who happen to be near the requesting user (“people around me now”).
Past proximity history (i.e. previous coincidences of location between those same users, and users connected to them), especially relevant if repeated periodically (which indicates repeated coincidence of events): “people that tend to be in the same places as me”.
“Virtual proximity”, measured in the same fashion as physical co-occurrence, but using as meeting point an online system (a group in a social network, discussion group, blog, etc.).

Existing systems and methods for social networks discovery or creation based on spatio-temporal proximity have not been applied to content recommendation, nor has spatio-temporal proximity been combined with online proximity in a seamless way. Moreover, existing solutions require user intervention at the time of linking devices, either by Bluetooth or other technologies. And also, many current solutions do not work indoors.

### DESCRIPTION OF THE PRESENT INVENTION

It is necessary to offer an alternative to the state of the art which covers the gaps found therein, particularly related to the lack of proposals which really permit the generation of content recommendations to users based on predicting affinity between users from spatio-temporal proximity information.

To that end, the present invention provides a method for generating content recommendations to users, wherein a first user is connected through a mobile device to a server, comprising determining a physical location of said first user mobile device.

On contrary to the known proposals, the method further comprises:

a) performing a frequency scan, said first user mobile device, to discover the presence of a plurality of other users' mobile devices in proximity;

b) obtaining, said first user mobile device, a network identifier for each one of said plurality of mobile devices discovered;

c) gathering and sending each one of said network identifiers to said server;

d) matching, said server, network identifiers received with other user identifiers known by said server,

e) predicting affinity between said first user and other based on an spatio-temporal clustering analysis, and

f) storing and analyzing, said server, said affinity prediction in order to provide said content recommendations upon said first user mobile device request.

In an embodiment, the affinity prediction of step e) can be performed based on information regarding the other users whose mobile devices are in proximity at the same time of the first user mobile device request or based on spatio-temporal information regarding said other users whose mobile devices were in proximity at a previous time of said first user mobile device request.

In another embodiment, a spatio-temporal affinity measure between the first user mobile device and each one of said plurality of mobile devices is computed in order to provide said content recommendations.

The spatio-temporal affinity measure, in another embodiment, can also be computed considering the activity of the users in online spaces, such as a group in a social network, a discussion group or a blog, among others.

In an embodiment, the content recommendation of step f) comprises:
recommending a product and/or a service content to said first user mobile device;
giving an explanation about why said first user mobile device would like said product and/or service content recommendation;
explaining said affinity to said first user mobile device;
giving information about said online spaces and information related to said physical proximity location.

Other embodiments of the method of the first aspect of the present invention are described according to appended claims 2 to 13, and in a subsequent section related to the detailed description of several embodiments.

A second aspect of the present invention concerns to a system for generating content recommendations to users, comprising a server and a user's mobile device. On contrary to the known proposals, said user's mobile device, is configured to receive said content recommendation and arranged for:
perform a frequency scan to discover the presence of a plurality of mobile devices in proximity;
obtain a network identifier for each one of said plurality of mobile devices discovered, and
gather and send each one of said network identifier to said server; and said server arranged to:
match the network identifiers received with other user identifiers known by said server,
predict affinity between said first user and other based on an spatio-temporal clustering analysis, and
store and analyze, said matching in order to provide said content recommendations upon said user's mobile device request.

The server further comprises:
a location module arranged to perform an analysis of the said proximity data;
an affinity module arranged to perform an analysis between said user's mobile device and each one of said plurality of mobile devices;
a cluster module arranged to create groups of clusters of similar nearby users;
a recommender engine to provide said content recommendation to said user's mobile device from each one of said plurality of mobile devices belonging to the same group of clusters;
a social network analyzer module arranged to analyze online activity of said users;
a sources manager module in charge of manage all of said online activity; and
a SN activity collector module arrange to gather all the online activity information analyzed.

The system of the second aspect of the invention is adapted to implement the method of the first aspect.

### BRIEF DESCRIPTION OF THE DRAWINGS

The previous and other advantages and features will be more fully understood from the following detailed description of embodiments, with reference to the attached drawings which must be considered in an illustrative and non-limiting manner, in which:

FIG. 1 shows an example of the basic concept of present invention. It shows how by using device-based co-location information to set or improve a global measure of profile user affinity.

FIG. 2 is a block diagram showing the detailed schema used for generating the content recommendation to users, according to an example embodiment of the present invention.

FIG. 3 is a representation of the w_{P} function in the switching model, according to an embodiment of the present invention.

FIG. 4 is a representation of the w_{P} function in the continuous model, according to an embodiment of the present invention.

FIG. 5 is a block diagram showing the steps to how the recommendations can be shown to the final user, according to an example embodiment of the present invention.

FIG. 6 is a sequence diagram illustrating the method of operation of the present invention, according to example an embodiment.

### DETAILED DESCRIPTION OF SEVERAL EMBODIMENTS

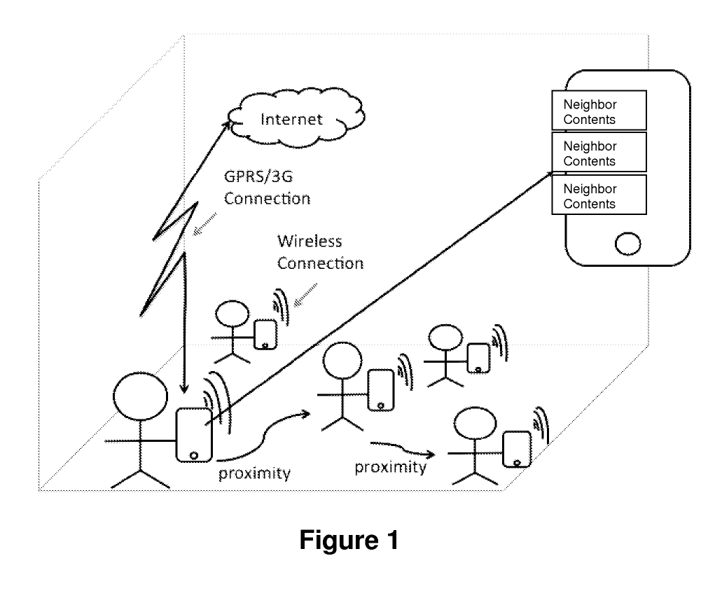

An example embodiment of the present invention provides a method and a system for generating content recommendation to users. As it is shown in FIG. 1, the invention uses device-based co-location information, as gathered through local pairings made automatically between mobile devices and sent to a server, to ascertain spatial, temporal and/or spatio-temporal coincidence of users in physical locations. The same procedure is used in the online area to establish “virtual coincidence” of users in online spaces. The outcome of both co-location data sources is fed to a system at the server side that determines an affinity measure between users based on those co-locations, which then is used to set or improve a global measure of profile user affinity. This helps produce informed user recommendations that include semantic, easy-to-grasp explanations of the source, thereby improving reliability, user interaction with the system and trust.

This has the added advantage of enabling more sophisticated behavioral pattern analysis at the server (by using proximity history for each device, and user graph connectivity), plus the possibility of improving profile similarity detection by matching content usage information available in the server for each user.

The fusion of all those types of information can provide with a new and reliable source of information for item recommendations, as a complement and improvement over usual techniques such as collaborative filtering engines and standard social recommendations through Webs of Trust.

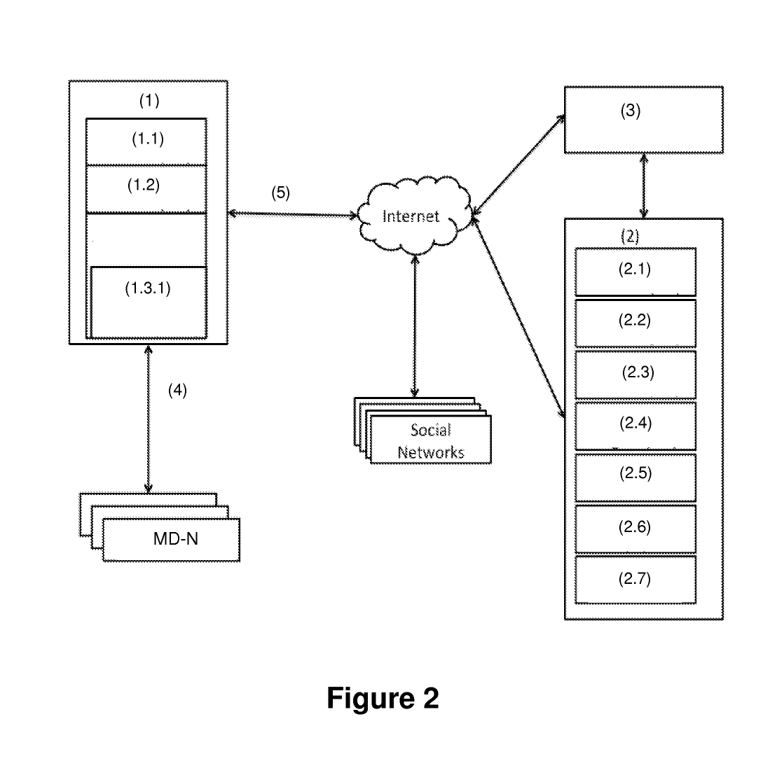

FIG. 2 is a detailed block diagram that shows the detailed schema used for generating the content recommendation to users. Broadly speaking, the physical co-location discovery and process system works as follows. A mobile device (1) performs a scan in order to discover other mobile devices (MD-N) (typically using Bluetooth, 802.11x wireless, etc.). Following this discovery the application sends all the devices identifier (typically the MAC of the adapter) to the server via a 3G/GPRS connection. At that moment the server (which also knows who the users of the system are) performs a matching between the user identifier and the identifier network received. At this moment the system knows who are the users sharing a physical location. For large areas, a network between all the users is intrinsically created which allows covering bigger areas of space, typically a sports stadium.

The invention consists of the following modules and elements: A Mobile Device (1) which has the following submodules: a Wireless Module (1.1) that provides wireless connectivity if available and that is embedded in the mobile device. A GPRS/3G Module (1.2) to provide mobile wireless connectivity if available and also embedded in the mobile device. A Mobile Application (1.3) that must be installed in all mobile devices involved in the system. This application discovers nearby devices and sends the relevant data to the server. It also includes a Device Discovery Module (1.3.1) to scan and discover nearby devices that also have the application installed.

A second module of the diagram is the Server (2). This innovative module stores the data received from the mobile devices (1) (i.e. spatio-temporal parameters) and analyzes them in order to provide content recommendations when requested. The analysis is performed not only over the users' instantaneous data, but over all the available data of each user up to the request time. This leads to a much richer user profile that can be used to group users more accurately and thus provide better recommendations.

This second module has the following submodules: a Location Module (2.1) that performs the analysis of the geographical data in order to determine which users are close to the one that requests the recommendation. An Affinity module (2.2) that performs the analysis of the user's stored data and gives an estimation on how similar they are. Only nearby users will be analyzed.

A Cluster module (2.3), which creates groups of similar nearby users. A Recommender engine (2.4) that provides content recommendations from the users who are in the same cluster and finally, an Online & Social Network Analyzer Module (2.5). The mission of (2.5) is to analyze online activity (including social network activity) for the concerned users. All gathered data will aid in determining user affinity, user profile and preferences. Eventually these preferences will be used to narrow preferences of all created clusters. The aim is to effectively improve recommendations for users. With the aid to create explanations for recommended items in profile analysis and source a Labeling of preferences is used. This labeling, will be obtained using clustering and natural language processing techniques not involved with the scope of this invention.

The second module (2) further has a Sources Manager module (2.6). This module is in charge of managing all social networks in a transparent matter for the system, and It provides a unique view of the relevant data for the whole system. Finally, a SN Activity Collector Module (2.7) has the mission to gather data from all sources registered in the system.

The third module (3) is used for managing the notifications between the mobile devices and the server (information retrieval, recommendation requests, device discovery, etc.).

Finally, the system also has a Wireless connection (4) allowing the direct exchange of content between two nearby users. This connection could be Wi-Fi, Bluetooth, etc. and a GRPS/3G connection (5) to provide the geographical location of the users in case they are indoors and GPS location is not available.

Proximity Detection and Cluster Creation:

The underlying idea is to combine different wireless technologies in order to create spatio-temporal clusters of people (i.e. groups of people joined together in the same place at the same time).

In this invention disclosure two kinds of technologies are combined. The first group is the non-physical referenced technologies and the second is the physical referenced one. The first one comprises technologies like Bluetooth, RFID, ZigBee, etc. The second one comprises technologies like GSM, GPRS, 3G/UMTS, etc. where the geographical position can be determined (some of them with a bigger error than others) using different mobile phone tracking techniques like cell triangulation, etc.

In the Bluetooth case the defined group cannot be physically located, since Bluetooth information is not tailored to any fixed reference point. If possible, IP-based, GSM, GPRS, 3G tower cell or 802.11x identification of members of the Bluetooth-defined group should be used to anchor the group to a spatial position, as detailed as possible.

In order to define the spatio-temporal data for each user a tuple as follows is used. Each cluster has a master user, which is the user who gathers all nearby identifiers and sent to the server. D denotes the collection of tuples and each tuple is defined as d={u, t, s, m} where u is a user, t is a time instant, s is the geographical position and m is the relative distance between the master and the user, m is calculated according to the strength of the received signal.

The cluster creation is done as follows: A mobile device scans the frequency spectrum in order to find other devices close to it. Then the mobile device obtains a network identifier (typically a mac address) for each device. Following, all gathered identifiers are sent to the server and finally the server matches the received identifiers with the users so the first cluster is created.

This process above is done for each mobile device with an available Internet connection.

On the server side the system evaluates each individual cluster with the aim to merge adjacent clusters in order to create bigger ones. Due to the use of short-range technologies, a mobile device can discover a cluster using e.g. Bluetooth while another one is created just several meters beyond which is actually the same cluster. The idea is to discover bigger clusters looking for adjacent clusters that have users in common.

A cluster is a subset of tuples meeting all of the following conditions.

∀dᵢ,dⱼεe,|dᵢ(s,m)−dⱼ(s,m)|≦δₘₐₓ

∀dᵢ,dⱼεe,|dᵢ(t)−dⱼ(t)|≦βₘₐₓ

That is, tuples are in the same location because are separated in distance at most δₘₐₓ. This relative distance d(s,m) are calculated according to the strength of the received signal. And tuples separated in time by at most βₘₐₓ

Once all clusters are created and for each cluster instance, a cluster weight is assigned, which is a function of the precision of the cluster (the physical closeness of its members, as defined by the tolerance of the clustering procedure, and the temporal duration of the cluster).

A cluster weight is defined as regarding space and temporal precision.

Spatial precision is defined (similar to [2]) as follows. The area of a cluster measures its spatial extension, S

$${X}_{i} = \frac{\frac{1}{S}}{\frac{1}{max S}}$$

where max S is the maximum area of all clusters. The temporal precision, is defined as follows:

$${T}_{i} = 1 - \frac{\frac{1}{δ}}{\frac{1}{max {δ}_{max}}}$$

Start time of the cluster is the time of the earlier tuple and end time of the cluster is the time of the end time of the latest tuple.

Computation of Spatio-Temporal Affinity:

Once the spatio-temporal clusters have been computed and stored in the server database, a process is launched to produce a global affinity matrix that gives, for each pair of users of the service, a measure of their spatio-temporal affinity AST. This value, in the interval [0:1], measures the degree to which those two users act together as a whole (i.e. their tendency to be in the same place at the same time). Given any service user, the AST value between this user and the rest of users in the system enables ranking all users in terms of “physical neighborhood” to the test user, and will be used to find out good candidates as sources of recommendation.

The process comprises three steps, mentioned in the next subsections. They are carried out for each possible pair of users U and V.

Spatio-Temporal Co-Occurrence Table:

The first step builds a co-occurrence table between U and V, that signals when and where U and V could be located together (i.e. where they are part of any defined spatio-temporal cluster). Table 1 shows an example of a spatio-temporal co-occurrence for users U and V, using 5 different locations at 6 time instants, for a total of 30 clusters:

| | L₁ | L₂ | L₃ | L₄ | L₅ |
|---|---|---|---|---|---|
| t₁ | uv | | | | |
| t₂ | | u | | v | |
| t₃ | | | | u | v |
| t₄ | | uv | | | |
| t₅ | | | | | |
| t₆ | | uv | | | |
| t₇ | u | | v | | |

Each cell in the table shows the situation at a concrete instant and at a given time slot (e.g. L₄t₃ shows that at t₃ user U was in L₄). For obvious reasons, each user appears only once per row, though she can appear any number of times per column (the more she appears, the most frequent that location is for her). It is also possible to find empty rows or columns: an empty column signals that none of both users was ever located there, and an empty row signals that during that time slot the users could not be located (because e.g. they were not using the service and so they did not communicate with the server).

Although in a service with a great number of active users the table can grow very large, its storage demands on the server are not very big, given that its structure is quite simple: for any user and cell, the only possible values are 0 or 1. Therefore, efficient data structures could be designed so that even for massive deployments the table could fit in a reasonably capable server.

However, in order to facilitate the set of operations described on the next two subsections, which are performed on table cells, the implementation for the table storage at the server follows instead the Big Table paradigm, in which data is distributed across several nodes.

User-User Affinity Matrix:

The co-occurrence table is used to perform the computation of a small 2×2 matrix that reflects the spatio-temporal affinity of any two users i.e. how they tend to associate in the same place and/or at the same time.

The invention begins with a raw affinity matrix M_{R} between users U and V:

$${M}_{R}^{uv} = ( \begin{matrix}{A}_{11} & {A}_{12} \\ {A}_{21} & {A}_{22}\end{matrix} ) \qquad ( Ec . 1 )$$

where the four matrix coefficients are computed from the co-occurrence table of U and V as equations (Ec. 2) to (Ec. 5) show. In the formulas, | [symbol] uv [symbol] _{T}| represents the cardinality of the set [symbol] uv [symbol] _{T}, which is the set of all cells containing uv across all times of a given location (likewise for u cells and v cells, as well as measuring across all locations of a given time). The values w_{Li} and w_{Ti} correspond to the weights of each location and time respectively.

$$\begin{matrix}{A}_{11}^{uv} = {\sum }_{L} {w}_{{L}_{i}} \frac{\vert {〈 uv 〉}_{T} \vert}{\vert {〈 u 〉}_{T} \vert + \vert {〈 v 〉}_{T} \vert + \vert {〈 uv 〉}_{T} \vert} & ( Ec . 2 ) \\ {A}_{12}^{uv} = {\sum }_{L} {w}_{{L}_{i}} \frac{\vert {〈 u 〉}_{T} \vert + \vert {〈 v 〉}_{T} \vert}{\vert {〈 u 〉}_{T} \vert + \vert {〈 v 〉}_{T} \vert + \vert {〈 uv 〉}_{T} \vert} & ( Ec . 3 ) \\ {A}_{21}^{uv} = {\sum }_{T} {w}_{{T}_{i}} \frac{\vert {〈 u 〉}_{L} \vert + \vert {〈 v 〉}_{L} \vert}{\vert {〈 u 〉}_{L} \vert + \vert {〈 v 〉}_{L} \vert + \vert {〈 uv 〉}_{L} \vert} & ( Ec . 4 ) \\ {A}_{22}^{uv} = {\sum }_{T} {w}_{{T}_{i}} \frac{\vert {〈 uv 〉}_{L} \vert}{\vert {〈 u 〉}_{L} \vert + \vert {〈 v 〉}_{L} \vert + \vert {〈 uv 〉}_{L} \vert} & ( Ec . 5 )\end{matrix}$$

The interpretation of those coefficients is direct: A₁₁^{uv} measures the tendency of U and V to be together at places, averaged over all places, while A₂₂^{uv} measures their tendency to be together at times, and averaged over all times. They are computed columnwise over the table, and then rowwise.

Likewise, A₁₂^{uv} measures their tendency to be at the same place, but at different times, while A₁₁^{uv} their probability to act at the same time but at different places. They are computed per row of the table and then summed across columns. Note that the rows of M_{R} always sum 1, therefore in practice only half of the values need to be computed.

These operations being very simple, but potentially across a very big table, make the computation a classical example that could benefit greatly from the MapReduce paradigm. In it a Map operation is distributed across several nodes containing sections of the table, and then a Reduce operation collects the results and produces the final value. For this reason the server system deploys the affinity matrix computation over a distributed table with MapReduce.

Given this raw affinity matrix M_{R}, a very simple operation creates the final user-user spatio-temporal affinity matrix M:

$${M}^{uv} = ( \begin{matrix}{A}_{11} & \frac{1}{2} ( {A}_{12} + {A}_{21} ) \\ \frac{1}{2} ( {A}_{12} + {A}_{21} ) & {A}_{22}\end{matrix} ) \qquad ( Ec . 6 )$$

That is, the non-diagonal coefficients of the matrix are averaged (since they represent alternative views of the same fact, users being not in the same time and same place, they have a rather similar meaning). This makes the M affinity matrix symmetric.

Spatio-Temporal Coverage and Final Affinity Value Computation:

The affinity matrix represents quite succinctly the common behavior of users U and V. However there is one fact from the co-occurrence table that has not influenced computation so far, and this is the existence of empty cells (cells in which neither U nor V have been registered).

This, however, is useful information which should influence the results, since the relevance of user co-occurrences is not the same for users with only a few instances in the table (i.e. inactive users) than for very active users which are registered at almost every moment and in many places. Intuitively, a high affinity for those later users carries much greater significance, since very active users make coincidences in time and place intrinsically more difficult.

For this reason an additional computation is done for each user: her spatio-temporal coverage, measured with a 2×1 matrix:

$${C}^{u} = ( \begin{matrix}{C}_{L}^{u} \\ {C}_{T}^{u}\end{matrix} ) = ( \begin{matrix}{\sum }_{L} {w}_{{L}_{i}} \frac{\vert {〈 u 〉}_{T} \vert + \vert {〈 v 〉}_{T} \vert + \vert {〈 uv 〉}_{T} \vert}{\vert {〈 u 〉}_{T} \vert + \vert {〈 v 〉}_{T} \vert + \vert {〈 uv 〉}_{T} \vert + \vert {〈 ∘ 〉}_{T} \vert} \\ {\sum }_{T} {w}_{{T}_{i}} ( \vert {〈 u 〉}_{L} \vert + \vert {〈 v 〉}_{L} \vert + \vert {〈 uv 〉}_{L} \vert )\end{matrix} ) \qquad ( Ec . 7 )$$

Note that for the temporal coverage C_{T}^{u} there is no need to normalize, since the value per row is always either 0 or 1.

Once the coverage for both users U and V is obtained, the final spatio-temporal affinity value between them is:

A^{ST}ᵤᵥ=(C^{u})^{T}·M^{uv}·^{v} (Ec. 8)

The server performs this computation periodically for all user pairs, and stores the result in its database, as a symmetric matrix showing all affinities between users.

Extension: Affinity Through Online Co-Occurrence:

The above procedure can be extended to take into account activity of the users of the service in online channels. By defining an equivalence between the physical co-occurrence in which the above defined affinity is based and corresponding entities in online spaces, it can be applied the same procedure to that online activity and, what is more powerful, combine physical and online activity (real and virtual behavior) to obtain a better picture of relationships between users.

Let us use as a simple example user activity gathered around a blogging service (it may be an editorialized blog, a thematic blog or even an online newspaper accepting comments to its news). In this context the equivalence of a physical place are the thematic clusters in the service (i.e. topics, or tags, or newspaper sections, or any semantic classification system), while the equivalence of a physical time is a blog thread, i.e. the original post/news item and the timeline of comment. They are considered as part of the same “virtual instant” in the semantic sense, in practical terms comments may well be spaced in time, but it shouldn't consider exact timestamps since conversations in online spaces tend to be more stretched across time than in the real world.

In this example, therefore, two users co-exist in the same space and time if they both comment, write or interact whatsoever in the same blog post (obviously of the same thematic section of the service). I.e. they participate in the same conversation, so to speak. And they act in the same space but at different times if they contribute to different posts on the same subject area (they come to the same place but do not interact directly). Correspondingly, they are at the same time but in different spaces if they participate in conversations that take place around the same timeframe but are located on different subjects.

Analogously to the physical co-occurrence case, in which users need not be personally acquainted to have a positive affinity (instead affinity is computed indirectly by their attending the same venue), in a “virtual” co-occurrence they need not have a direct and established online relationships (e.g. a declared social-network friendship), their affinity being computed instead by their attending the same virtual venue (showing them features of common interests). Though of course, both in the physical and in the online areas, personally acquainted users are not excluded from the computations. In fact, the final global affinity evaluated will take care of combining (and if appropriate reinforcing) affinity measures computed via the spatio-temporal affinity with “traditional” affinity computed through profile matching or direct explicitly stated relationships.

From this analogy it is straightforward to construct the co-occurrence table and henceforth the affinity matrix, which then can be operated upon in the same fashion as for physical spatio-temporal co-occurrence. Similar to this example it could be construct others based on different types of online social services.

The ultimate power of the invention is unleashed when it can combine both types of affinity, physical and online, thereby constructing a much more accurate profile of relationships between users that cares for both the affinities they showing the real world and online (which may or may not overlap).

Variation: Temporal Recurring Patterns:

Although the above detailed process is the most general one, and will produce the most exact affinity values between users, in cases in which user activity is low and/or scattered across many different places and times, the final affinities might span a small dynamic range, concentrated near zero.

For this reason the present invention proposes also an alternative procedure in which the rows of the co-occurrence table are transformed from concrete time instants into periodically recurring intervals, such as “weekday mornings”, or “Friday evenings”. For instance, one very typical arrangement would be to produce 3×2=6 periodic intervals, as the product of

(morning,afternoon,evening/night)×(weekday,weekend)

There are many possible arrangements; the right one in each case will depend in user behavior and purpose of offered service.

The mechanics for computation of spatio-temporal affinity remain largely the same, with the caveat that the co-occurrence table now contains not only 0 and 1, but integer numbers ranging from 0 onwards. The formulas are adjusted accordingly.

It can be noted that the demands on co-occurrence are relaxed in this case: to count as a coincidence event the invention doesn't need the two users begin in the same place and at the same time. It is enough for them to be at the same time in equivalent time periods (e.g. they visit the same place on weekend nights, though not necessarily in the same weekend). Though it is clear that the association between those two users is now weaker, the semantics of affinity values still hold, in the sense that they express the fact that those two users tend to do similar or equivalent actions, at least part of the time.

Profile Affinity and Final Global Affinity:

The final global affinity A between two users U, V of the system is computed by a linear combination of the above defined spatio-temporal affinity with a profile affinity, computed by matching the profiles of the two users u and v:

A^{uv}=(1−w_{P})·A_{ST}^{uv}+w_{P}·A_{P}^{uv} (Ec. 9)

Here A_{P} is a measure of the similarity of the two profiles, and its computation depends on the application domain and the intended use of the global affinity. For instance, in recommendation engines it could be:
For content-based recommendation, some measure of correlation between the two user's profiles. E.g., if it follows the vector space model for defining the profiles, it could be defined as the cosine distance between the vectors corresponding to the two profiles.
For collaborative filtering, especially for user-user neighborhood models, it can use the neighboring metric in the user-item matrix for the CF engine.
For social recommendations, relationships and distance metrics between users as extracted from a social graph.

Whatever the domain and the method applied, in the general case it has user profiles that, when considered in isolation, can already provide a similarity between users (which in turn is used in the recommendation engine to find items of potential interest for the user being evaluated). In many cases, however, profile similarity falls short of the needs in term of finding neighbors: cold-start users or users with low service activity lack enough profile differentiation to be able to obtain similar profiles, and in services with not very deep user bases it can also happen that content areas with potential recommendation value remain unexploited because of lack of matches between users (thereby negatively affecting recommendation diversity).

It is because of these reasons that adding spatio-temporal affinity to the computation of neighbors can greatly improve the service. Therefore, the purpose of equation (Ec. 9) is to increase the capacity of finding suitable neighbors in the cases in which profile affinity does not yield good results. The parameter w_{P} adjusts the relative weight of each affinity source, so that the invention ensures a proper match in most cases.

To provide a better adaptation, w_{P} can be made dependent on the individual affinity values, i.e. a function w_{P}=f(A_{ST}, A_{P}). In this way it can take advantage of both affinity sources in the optimum combination.

There are many possible expressions for the w_{P} function. In the next subsections are described three of them, from the most basic to more elaborate variants.

Simple Switching:

The simplest model is that of switching between the two affinity modes based on a fixed threshold, i.e.

$${w}_{P} ( {A}_{P} ) = \{ \begin{matrix}0 & if & {A}_{P} < T \\ 1 & if & {A}_{P} \geq T\end{matrix} \qquad ( Ec . 10 )$$

The only parameter to be obtained for this model is the threshold T, which sets the profile affinity value above which the invention will only use profile information (and only spatio-temporal affinity below it). Intuitively, the rationale for this model is as follows:
When the two users have a very similar profile, this in itself should be enough to declare them as neighbours, regardless of their spatial closeness (it may well be that they are in fact highly related also through spatio-temporal measures, since a common source of both high A_{P} and high A_{ST} is their belonging to the same social cluster; in that sense this approach would complement that of a social recommender [ ]).
If, however, their profiles do not match (as explained, it might e.g. be because of cold start situations or lack of service activity), then the invention switches to using spatio-temporal activity as the criterion to determine them as neighbors: if their A_{ST} is high, they will be treated as such and therefore increase the set of recommendation sources.

FIG. 3 shows a representation of this simple switching w_{P} function. The model parameter T can be set heuristically, or it can be adjusted by a training process: if the service activity allows acquiring a dataset of users activity as well as enough spatio-temporal cluster information across a time period, then that dataset can be used as a training set, and adapt the value of T for optimum performance across that training set.

How to do the training depends on the performance measure chosen. Two approaches are mentioned:
1. End-to-end optimization uses a performance measure taken from the final use of the system, i.e. as a recommendation engine. This requires the dataset to contain final preference values for the recommended items (obtained e.g. through user ratings). If such data is available, T can be adjusted to minimize the MRSE between the preference prediction given by the engine and the actual user rating, averaged across the training set.
2. Neighbour optimization uses as a performance measure the intermediate output given by the set of neighbours found by the procedure. Depending on the decided criterion, it can be adjusted for size or for affinity:
   If it is fixed on a minimum value Amin to declare a neighbour as valid, then the optimization procedure is done to maximize the average total number of valid neighbours (i.e. neighbours with A>Amin) obtained for each user.
   If it is set on a fixed set of neighbours per user N, then T can be optimized so that the average overall user affinity for each set of N neighbours per user is maximum (or, alternatively, the average minimum neighbour affinity).

Basic Thresholding:

This model is quite similar to the previous one, but in this case instead of total switching it alternates between two specific values for w_{P}:

$${w}_{P} ( {A}_{P} ) = \{ \begin{matrix}{w}_{l} & if & {A}_{P} < T \\ {w}_{h} & if & {A}_{P} \geq T\end{matrix} with \begin{matrix}{w}_{l} > 0 \\ {w}_{l} < {w}_{h} \\ {w}_{h} < 1\end{matrix} \qquad ( 11 )$$

So the model now contains three adjustable parameters, wₗ, wₕ and T. As for the previous case, given an available dataset, it could train the system to optimize those parameters.

Continuous Mapping:

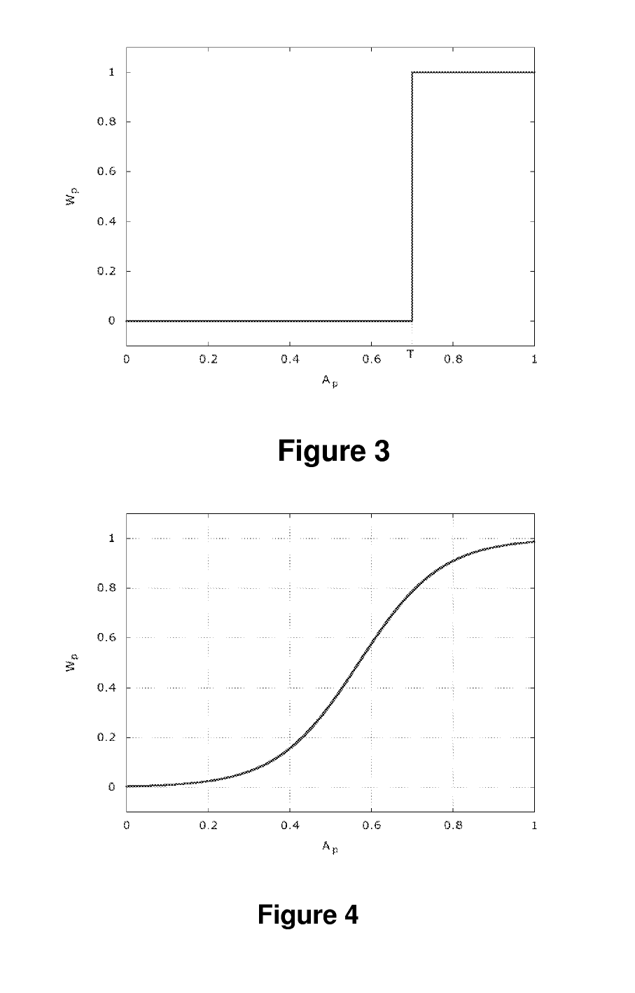

The final example, FIG. 4, shows a function that avoids discontinuities in behavior. Instead, a sigmoid is fitted to the [0.1] interval so that there is always a mix between both affinities to compute the final value. Adjustment of the parameters of the sigmoid enables to fit the behavior to the desired balance between those two affinities, moving the slope change point and/or changing the slope of the function.

Item Recommendation:

Content recommendation is implemented through an engine that uses the above computed user affinity as the key factor to match users and hence find out content items a given user might be interested in. As mentioned, affinity can be fed to different engine types, such as a CF engine, a Content Based engine or a Social Recommendation engine, among others. The exact shape of the engine is not part of this proposed invention.

One very simple embodiment runs as follows: Users manage their content lists using an application running in their mobile phone. This application allows users to manage contents in different ways, watch-later, recommended contents, etc. Once determined a cluster all users who belong that cluster can get content recommendations coming from the others members of the cluster according to the following algorithm:

| | |
|---|---|
| • | Input: cluster C, user U |
| • | Output: array of recommended contents RC |
| • | Algorithm |
| | for each user u of C do |

affinity = evaluate afinity (U, u)
if affinity then

contents = get_contents_user_like(u)
add_contents(contents,U)

enf-if

end-for

Recommendation Delivery:

Once the recommendations have been created, they have to be delivered to the user. It has been widely recognized that the way in which they are presented to the user and the information associated to the recommendations themselves can produce a big impact in the perceived relevance of the recommended items, and as a consequence in their acceptance ratio.

In that sense, explanation of the reasons for a recommendation is a key factor to increase relevance [4]. Knowing why a certain item has been chosen by the engine provides the user with a much better context helps her to ascertain the real relevance of the item and increases enormously the transparency of the service. With increased transparency comes increased trust, which helps cement a loyalty and makes the user return to the system.

To achieve those explanations the proposed invention provides a differential advantage: its procedure to construct the affinity can be related to events (spatio-temporal occurrence, be it physical or online) easily grasped by end users. So those constructed explanations (e.g. “this was recommended to you because people you often meet at the park liked it”, or “people that go to the same bars as you tend to like it”) can be presented to the user and will help her to make up her mind on the appropriateness of the recommendation. Confidence in the system is thus improved.

Moreover, this also enables direct profile modification by the user. If a user perceives that his taste does not really match the movies liked by the gang he usually plays football with on Saturday mornings (as detected by the engine and faithfully communicated to him) he could easily indicate that to the system (“black me out that physical spot as source of movie recommendations”) and his profile will be accordingly improved. This has been made possible precisely by the ability of the system to identify the reason of the detected affinity, and the fact that reason is clearly understandable and can be easily separated from other sources of user affinity (which is not so easy in a classical CF engine).

Embodiment Layout:

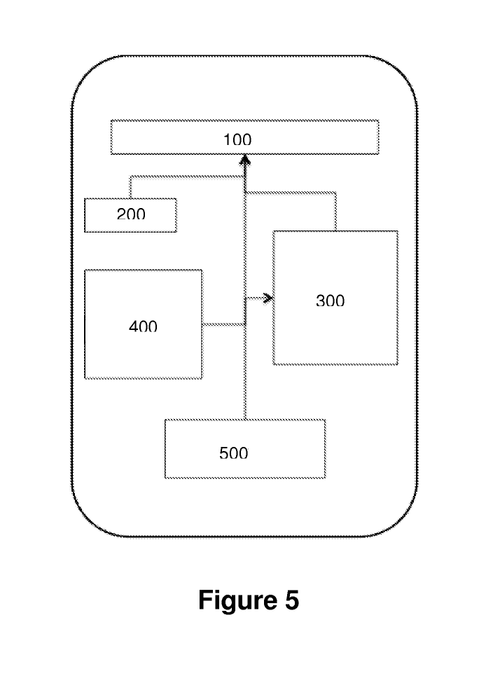

FIG. 5 is a block diagram showing the steps to how the recommendations can be shown to the final user, according to an example embodiment of the present invention. The different blocks of the figure are described as follows: A recommendation module (100) recommends the product or service that the system wants to address to the final user. The Why block (200) gives a short explanation about why the user would like this. The Cluster Belonging affinity explanation (300) further gives an explanation about explaining the cluster affinity where the user belongs. A Social Network Explanation (400) gives information about social network activity and preferences done by related people of the user and finally, the Proximity cluster explanation (500) as (300) it shows all data related to physical proximity.

System Operation:

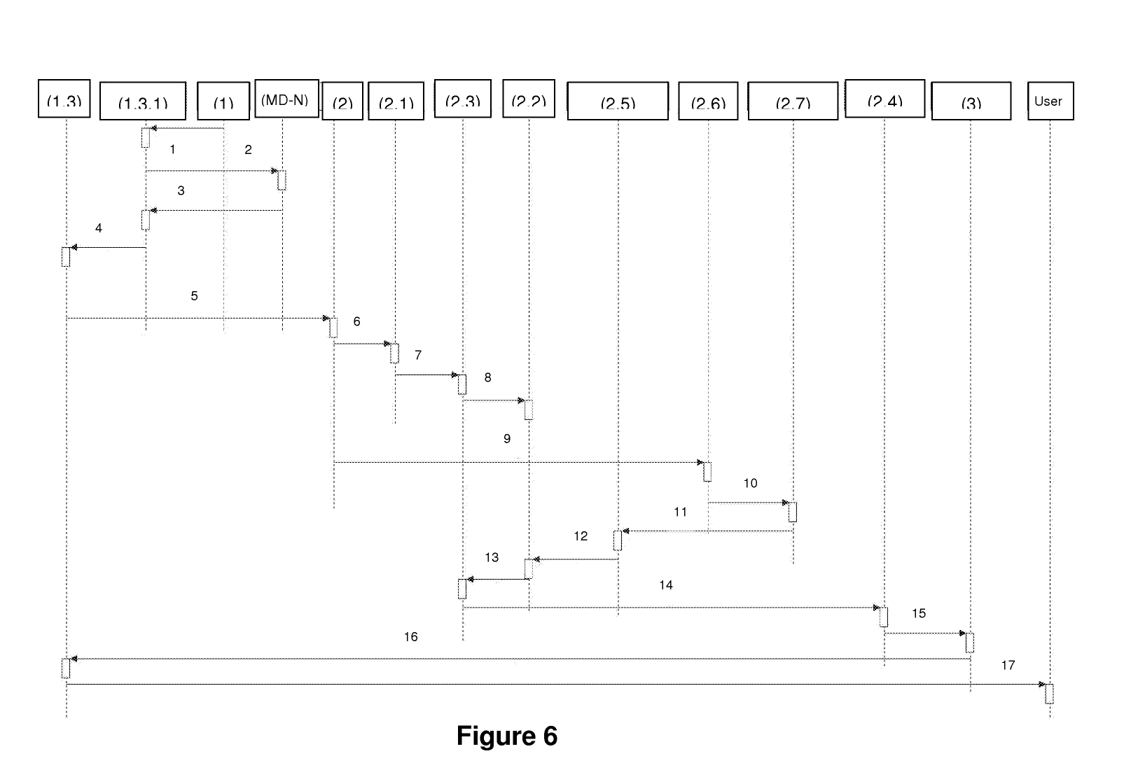

FIG. 6 is a sequence diagram illustrating the method of operation of the present invention. The system workflow is explained in brief:
1. Mobile Device (1) asks the device discovery module (1.3.1) to perform a search.
2. The device discovery module (1.3.1) performs a device discovery search in order to obtain the “Media Access Control Address” MAC of nearby devices.
3. All mobile devices (MD-N) in the area send the MAC to the master mobile device.
4. All gathered MAC addresses are provided by the device discovery module (1.3.1).
5. The mobile application (1.3) sends the gathered MAC addresses to the server (2).
6. The server (2) asks for a user matching to the location module (2.1).
7. The server asks the Cluster Module (2.3) in order to create location clusters.
8. Affinities between users are evaluated (2.2).
9. In background mode the server (2) asks sources manager (2.6) to obtain social affinity.
10. Sources Manager (2.6) asks SN Activity Collector Module (2.7) for data. This module will crawl all sources configured in the sources manager (2.6) in order to obtain the most data as possible from the social networks.
11. All gathered data are sent to the Social Network Analyser Module (2.5) to evaluate relevant data for each user.
12. That information is provided to the Affinity Module (2.2) in order to improve the cluster creation.
13. Affinity module (2.2) evaluates data and provides information to the cluster module (2.3) in order to narrow clusters creation.
14. Cluster Module (2.3) sends all clusters and preferences to the Recommendation Engine (2.4) in order to evaluate proper recommendations for each user.
15. The recommendation engine (2.4) provides recommendations according to the previously calculated affinity for each cluster.
16. The notification server (3) sends the recommendations to the application (1.3).
17. Finally, the mobile application (1.3) informs the user about these recommendations (using audible signals, visual signals, etc.) according the interface previously explained.

### ADVANTAGES OF THE INVENTION

The system does not need to map locations to specific positions in space, saving costly geo-positioning work. It is enough to know that a co-occurrence place exists, without knowing its exact location or purpose. High precision is therefore not needed. Moreover, only one device in the ad-hoc network needs to transmit its approximate position; the paired devices are mapped to that location at server side.
Furthermore, the ability to compute and use a measure of spatio-temporal affinity (instead of simple spatial affinity) means an increased probability of matches: users need not be physically co-located to be able to be linked. Peers can be found by any or both of spatial and temporal affinity and the procedure takes care of adjusting the degree of final affinity to accumulate both types of proximity.
The variation with temporal recurring patterns can further improve the search for affine candidates
The capacity to cater to users with very distinct levels of activity is integrated within the process by means of weighting through the spatio-temporal coverage. This enables the invention to work well across quite different user profiles (in terms of their behavior) and effectively incorporate their spatio-temporal feedback into the system, without fear of introducing imbalances or letting a few very active users ‘impose’ their tastes.
As a side benefit, privacy is enhanced compared to standard location-based services, since the actual exact position of users need not be recorded.
It is not intrusive with respect to the paired devices and users: users do not need to know or share any specific application to link the devices, and since most of the processing is done at server side, minimal installation at the terminal side is needed.
Physical proximity also works indoors (i.e. does not need to be outdoors as a traditional GPS).
The use of an equivalent procedure for online affinity enables obtaining a measure for activity of the users in the online sphere that is based on the same metrics as, and is therefore easily combined with, physical spatio-temporal affinity. Therefore it becomes possible to join both worlds of users activity to obtain an unified view of their profiles.
User affinity works in a similar way to social proximity, as measured in a social graph. Therefore it can be subjected to the same processes as social recommenders do (for instance, it can build a Web of Trust from the affinity matrix).
It is however complementary to social information, so it can work in situations in which social processing cannot (e.g. because users have not declared explicit social contacts, or they cannot easily inferred from their social behavior). Construction of the affinity matrix is a purely passive process from the users' point of view: they do not need to make any effort.
The ability to work in dual configurations (with concrete time instants or with periodic intervals or temporal recurring patterns) provides versatility to better adapt to each specific case, and can further improve the search for affine candidates
It combines in a perfect way with standard user matching via profile comparison. The combination process ensures the right mix is done, so that spatio-temporal affinity kicks in only when it is needed. In this sense it is neither a substitute for ‘traditional’ user profiling nor a mere complement, and the ability to use different combination functions, with varying degrees of sophistication, ensures a better adaptation to the domain and context.
It works effectively towards reducing cold start problems, by finding additional contacts to connect to in a recommendation engine.
The clear semantics of the affinity computation enables relating the result of a recommendation engine to the source data used to obtain it; this provides an explanation for the procedure that can be conveyed to the user, therefore increasing transparency in a shape easily grasped by users of the service.
Transparency is further aided by the possibility for the end user to “tune” the engine by actively modifying the detected physical and online connections used in her profile. In turn, this may increase performance (relevance of results) and therefore user satisfaction.

### ACRONYMS

CB Content-Based (recommendation engine)

### CF Collaborative Filtering

### GPS Global Position System

### MAC Media Access Control

### MRSE Minimum Root Squared Error

### REFERENCES

1. Jason J. Jung, Contextualized mobile recommendation service based on interactive social network discovered from mobile users, Expert Systems with Applications. Volume 36, Issue 9, November 2009,
2. H. W. Lauw, E-P Lim, H. Pang, T-T. Tan, STEvent: Spatio-temporal event model for social network discovery, ACM Transactions on Information Systems, Vol. 28, No. 3, Article 15, June 2010.
3. L. Backstrom, E. Sun, C. Marlow, Find me if you can: improving geographical prediction with social and spatial proximity, WWW '10 Proceedings of the 19th international conference on World wide web
4. N. Tintarev, “A Survey of Explanations in Recommender Systems”, IEEE 23rd International Conference on Data Engineering, April 2007

1. A method for generating context-based content recommendations to users, wherein a first user is connected through a mobile device to a server, comprising determining a physical location of said first user mobile device, the method further comprising:
a) performing a frequency scan, said first user mobile device, to discover the presence of a plurality of other users' mobile devices in proximity;
b) obtaining, said first user mobile device, a network identifier for each one of said plurality of mobile devices discovered;
c) gathering and sending each one of said network identifiers to said server;
d) matching, said server, said network identifiers received with other user identifiers known by said server,
e) predicting affinity between said first user and other based on an spatio-temporal clustering analysis, and
f) storing and analyzing said affinity prediction, said server, in order to provide said content recommendations upon said first user mobile device request.

2. A method according to claim 1, characterized in that obtaining said network identifier comprises obtaining a MAC address of each one of said plurality of mobile devices.

3. A method according to claim 1, characterized in that it comprises performing said affinity prediction in said step e) based on information regarding other users whose mobile devices are in proximity at the same time of said first user mobile device request.

4. A method according to claim 1, characterized in that it comprises performing said affinity prediction in said step e) based on spatio-temporal information regarding said other users whose mobile devices were in proximity at a previous time of said first user mobile device request.

5. A method according to claim 1, characterized in that it comprises performing said affinity prediction in said step e) based on spatio-temporal information regarding said other users whose mobile devices were active in previous occasions and at the same time of said first user former mobile device requests.

6. A method according to claim 1, characterized in that it comprises performing said affinity prediction in said step e) based on spatio-temporal information regarding said other users whose mobile devices were active in previous occasions and at equivalent time periods, said equivalent time periods taken from a predefined set of recurring periodic time intervals of said first user former mobile device requests.

7. A method according to claim 1, characterized in that it comprises performing said affinity prediction in said step e) based on combining the spatio-temporal information regarding said other users as specified by:
information regarding other users whose mobile devices are in proximity at the same time of said first user mobile device request;
spatio-temporal information regarding said other users whose mobile devices were in proximity at a previous time of said first user mobile device request;
spatio-temporal information regarding said other users whose mobile devices were active in previous occasions and at the same time of said first user former mobile device requests; and
spatio-temporal information regarding said other users whose mobile devices were active in previous occasions and at equivalent time periods, said equivalent time periods taken from a predefined set of recurring periodic time intervals of said first user former mobile device requests.

8. A method according to claim 1, characterized in that it comprises computing the spatio-temporal affinity measure between said first user mobile device and each one of said plurality of mobile devices in order to provide said content recommendations.

9. A method according to claim 8, further comprising computing said spatio-temporal affinity measure considering activity of the users in online spaces.

10. A method according to claim 9, characterized in that said online spaces are: a group in a social network, a discussion group, a blog, among others.

11. A method according to claim 8, characterized in that the final affinity between two users is as a combination of said spatio-temporal affinity and a measure of the similarity of the two profiles of said two users, when said similarity metric is a cosine distance in a vector space model for user features, a neighborhood metric for the matrix of preferences in collaborative filtering, a distance metric extracted from a social graph, among others.

12. A method according to claim 11, in which said combination is a linear combination of said spatio-temporal affinity with said user profile similarity, with adjustable weights providing the level or relative importance for said two operands.

13. A method according to claim 1, characterized in that said content recommendation comprises:
recommending a product, a service and/or a content item to said first user mobile device;
giving an explanation about why said first user mobile device would like said product and/or service content recommendation;
explaining said affinity to said first user mobile device;
giving information about said online spaces and information related to said physical proximity location.

14. A system for generating context-based content recommendations to users, said system comprising a server and a user's mobile device, characterized in that:
said user's mobile device, being configured to receive said content recommendation and arranged for:
perform a frequency scan to discover the presence of a plurality of mobile devices in proximity;
obtain a network identifier for each one of said plurality of mobile devices discovered, and
gather and send each one of said network identifier to said server, and
said server arranged to:
match the network identifiers received with other user identifiers known by said server,
predict affinity between said first user and other based on an spatio-temporal clustering analysis, and
store and analyze, said matching in order to provide said content recommendations upon said user's mobile device request.

15. A system according to claim 14, characterized in that said server further comprises:
a location module arranged to perform an analysis of the said proximity data;
an affinity module arranged to perform an analysis between said user's mobile device and each one of said plurality of mobile devices;
a cluster module arranged to create groups of clusters of similar nearby users;
a recommender engine to provide said content recommendation to said user's mobile device from each one of said plurality of mobile devices belonging to the same group of clusters;
a social network analyzer module arranged to analyze online activity of said users;
a sources manager module in charge of manage all of said online activity; and
a SN activity collector module arrange to gather all the online activity information analyzed.

16. A system comprising a server and a user's mobile device adapted to implement the method of claim 1.
